(19) United States
(12) Patent Application Publication
(10) Pub. No.: US 2016/0292539 A1
(43) Pub. Date: Oct. 6, 2016

(54) METHOD FOR ASSOCIATING OBJECTS WITH OBJECT CLASSES AND DEVICE FOR SORTING OBJECTS

(71) Applicant: SIEMENS AKTIENGESELLSCHAFT, München (DE)

(72) Inventors: DIETMAR KRECH, KAISERSLAUTERN (DE); ZHE LI, KONSTANZ (DE); HOLGER PAETSCH, KOENIGS WUSTERHAUSEN (DE); INGOLF RAUH, REICHENAU (DE); MATTHIAS SCHULTE-AUSTUM, RADOLFZELL (DE); STEPHAN VON DER NUELL, KONSTANZ (DE)

(73) Assignee: Siemens Aktiengesellschaft, Munchen (DE)

(21) Appl. No.: 15/038,499

(22) PCT Filed: Nov. 17, 2014
(86) PCT No.: PCT/EP2014/074715

§ 371 Date: May 23, 2016

(30) Foreign Application Priority Data
Nov. 21, 2013 (DE) 10 2013 223 768.5

(51) Int. Cl. G06K 9/62; G06K 9/00; G06Q 10/08; B07C 5/342

(52) U.S. Cl. CPC G06K 9/6281; B07C 5/342; G06K 9/6202; G06K 9/626; G06K 9/00201; G06Q 10/087

(57) ABSTRACT

A method associates objects with object classes. In order to render an association efficient, an object is optically captured, object characteristics describing the object are created from the optical data obtained there from, and the object characteristics are compared with a plurality of class characteristics, each of which is characteristic of one of a plurality of object classes. The object is then associated with an object class in accordance with the result of the comparison.

The invention relates to a method for associating objects with object classes

Retail products are usually transported by truck from a warehouse to individual retail outlets. In the warehouses the products are collected together, stacked in transport containers and said containers are moved into the trucks. To collect the goods together for a truck the goods are taken in packaging containers from high bay warehouses and moved with the aid of transport means, for example fork lift trucks, to a collection point and collected together there for the truck.

The object of the present invention is to specify a device and a method for rapidly associating objects with object classes.

This object is achieved by a method of the type stated at the outset, in which an object is captured optically, an object characteristic describing the object is created from the optical data obtained thereby and the object characteristic is compared with a number of class characteristics, which are characteristic for one of a number of object classes in each case, and the object is associated with at least one object class as a function of the result of the comparison.

The invention is based on the idea that the collection of goods for one or more trucks, in a freight center or warehouse for example, can be simplified if the goods are recognized by image recognition methods to the extent that they can be associated with a goods class, or in general terms with an object class. This enables a plurality of goods intended for a number of trucks to be put onto a transport belt, the goods are recognized and allocated to a goods class, which in its turn is associated with a truck. The goods recognized and allocated to a goods class can be sorted in an automated manner and routed to the truck accordingly. For example as many goods of one class are placed on a transport belt in a warehouse as are needed for supplying all branches of a retail chain. Likewise a plurality of goods is moved so that in each case a number of goods or individual goods of different goods classes are placed on the belt in different locations. At a point of the belt beyond which no further goods are added, e.g. before the first belt branch which divides the stream of goods onto a number of belts for a number of trucks, the goods class must be determined for each goods item, so that the sorter can sort the correct type and quantity of goods for each individual truck.

The objects can be goods, especially containers of goods, which each contain a number of elements held together by packaging, such as individual goods. Such a container can be a cardboard box with a number of tins, a number of bottles enclosed in outer packaging, a number of packs of toilet paper held together by film or the like. Advantageously a goods container contains a number of the same individual goods, which are especially identical with one another. The invention is able to be used for other objects to be sorted however, for example items of baggage, which are sorted in a baggage sorting system to a number of aircraft, packages or other products or goods to be sorted.

Advantageously there is precisely one object class present for each goods type, so that a goods type can be associated uniquely with an individual object class. It is also possible for a number of object classes to be present for one goods type. Thus it can occur that a manufacturer leaves a product entirely the same and only changes the surrounding packaging slightly, wherein even a barcode can remain unchanged. In this case the objects are optically different but are identical as regards the content, i.e. the type of goods. Each of the two objects that are optically different but with the same content now form a goods class, or more generally an object class. A goods type or object type thus expediently contains all content-identical goods or objects, which can be optically different however. Each goods class or object class contains only goods or objects identical in content and optically the same.

Advantageously the object classes describe specific goods or goods classes, especially precisely one single specific goods item or goods class. A goods class or a goods type can be an orderable product, especially a container of individual goods, wherein two products of one goods class are expediently identical in content and also optically identical to one another and goods with a different order number are expediently always associated with different goods classes or object classes. An object class can thus comprise a number of objects, which must be an identical design however. The identity expediently comprises all features of the object, where necessary right down to an identification code, which specifies a date of manufacture and/or makes product tracing possible for example. An object is for example a container with a number of individual goods items of one manufacturer and one type, such as a cardboard box with twelve tins of ravioli made by one company and of one sort.

Each object class expediently has precisely one class characteristic. Each class characteristic is thus associated with precisely one object class here. To create class characteristics an image of an object or a plurality of identical objects is captured, expediently from a number of directions in each case, especially with a number of cameras. Although such objects are identical as regards their type, they can have slight variations in form or color, for example if a cardboard box has slight dents or scratches or is dirty on the outside. From the recorded images of the number of identical objects a class characteristic for these objects, i.e. for this object type, is created, which has form features, color features, brilliance features, pattern features, character features and/or ID features, such as a barcode. Since the identical objects can exhibit a feature variance because of damage or soiling, each class characteristic is assigned a feature variance, so that the object class captures even slightly damaged and/or soiled objects of its object type.

For the association of the individual objects with the object classes, the objects intended for classification are expediently each also recorded from a number of directions, especially with a number of cameras and on these captured images an object characteristic is created for each object. Each object characteristic is compared with a number of class characteristics, especially the characteristics of all classes and on successful classification is expediently associated with that class of which the class characteristic exhibits the greatest match with the object characteristic.

An advantageous form of embodiment of the invention makes provision for the objects to be containers of a number of individual goods packed contiguously in the container, especially the same individual goods, and for the object classes to be container types. A container type here expediently only features a single container and such containers as are identical with this container. The assignment of a container to the container type enables it to be established which goods are in the container, and the container can be sorted in an automated manner, onto one of a number of transport units for example.

Since manufacturers are always changing the optical appearance of goods, it frequently occurs that a new object lies on the transport belt. Its object characteristic cannot be associated with any existing class characteristic. Sorting can now take place by the object characteristic of the new object being associated by an operator, e.g. via video coding, with a goods class. The object characteristic can then be converted into a class characteristic and inserted into the set of the existing class characteristics, so that a new set with an additional class characteristic is produced. Formulated in more general terms, from a single new object—or from one or more images of the object—a class characteristic is formed and is inserted into an existing set of class characteristics. The existing class characteristics here expediently remain unchanged. They can form a new set with the new class characteristic, so that the comparison with the new set can be carried out. In this way new goods can be recognized quickly and easily.

The insertion of a new class characteristic into a set of existing class characteristics can be kept simple if the object characteristic and the class characteristics each form a container, especially a point, in a multi-dimensional feature space and the comparison takes account of a distance of the container or point of the object characteristic from the containers or points of the class characteristics. The modification of the existing class characteristics on insertion of a new class characteristic into the set can be dispensed with.

In addition it is proposed that the object characteristic contains a number of object features and the class characteristics contain a number of class features in each case. Object features and class features are associated with feature types, e.g. form, color, volume, mark and the like. The object features can be compared with those class features that are of the same feature type. Each object feature type is expediently associated with precisely one class feature type here, so that a direct comparison between features associated with each other is possible.

Advantageously, for the comparison, each of the object features is allocated to a respective feature type that comprises a number of elements, which in their entirety form an especially self-contained feature search space. Each object feature can be sought in the feature search space of its feature type. A feature candidate list with a number of feature candidates can be created, each of which is provided with a similarity value.

The object features can be grouped as a vector consisting of a number of vector elements, wherein a vector represents the complete object characteristic. Each object feature can be represented as a vector element, which are combined overall into a total vector or into a number of individual vectors, which in their entirety once again form the object characteristic. The vector defines a point in the property space, which expediently is spanned in total or partly by the sum of the class characteristics.

The reliability of the classification can be enhanced if the class features are allocated different weightings. A result of a feature comparison can be weighted with the weighting, so that for example reliable features or features with a small variance are given a greater weight than more unreliable features or features with a greater variance. The weighting can be general so that, regardless of the object or the class, one feature type is generally given a greater weighting than others. The weighting can also be class-dependent however, so that the weighting of a feature differs from class to class.

With retail goods in particular it can occur that the same goods are sold in containers of different sizes. In order to be able to distinguish between such different containers, it is advantageous for overall features of the container image to be given a higher weighting than features of the individual goods. Overall features are features of the container that are absent from an individual goods item, especially features of the container as a whole. For example the features of the container packaging are given a higher weighting than features of the individual goods items. This enables the situation to be avoided in which, although the individual goods are recognized without any problems, the container size is ignored however as a not-so-important feature and is therefore classified incorrectly. It is also possible to suppress the features of the individual goods, i.e. to set the weighting to zero.

It is also advantageous for a script feature on a package to be given a higher weighting than a form feature of the object. A script feature can be a feature that is very reliably recognized, which also has a high degree of expressiveness in respect of the classification. The script feature must not be a feature that directly describes the object, but can only describe the object indirectly, for example a weight specification, a name of a packaging manufacturer or nutritional value information. With the same advantage an ID code feature, for example a barcode, on outer packaging—e.g. a container package—is given a higher weighting than a script feature on the outer packaging.

With goods in particular it can occur that a manufacturer delivers a number of containers of different goods types of very similar appearance, for example cartons with packet soups of different flavors. These objects can have the same optical features, which are very powerful differentiators per se, and could be highly weighted, but are not suitable for a differentiation in this case. In order, despite this, to arrive at a reliable distinction, it is advantageous for the object features to be weighted reciprocally to the frequency of their occurrence in the class characteristics. The occurrence in the class characteristics expediently relates only to a subset of class characteristics, i.e. only a part of the set of all class characteristics, especially only to those class characteristics which have been found in a pre-selection as class characteristics similar to the object.

A further advantageous form of embodiment of the invention makes provision for a classification result to be established from the comparison of individual object features and/or object feature groups, so that a number of classification results are obtained. An overall result can be obtained from the individual classification results. The individual classification results are expediently weighted here and are introduced in weighted form into the overall result, or the weighting is already contained in the classification results.

Advantageously at least a few of the object features are combined into groups, wherein these features are each compared in groups with corresponding class features and at least one group comparison result is obtained. This can be used to particular advantage for object features of the same type, for example the color features red, blue, green or form features, such as the dimension features height, width, depth. From the individual object features a group feature, a color or a volume can be established, which is then compared as such with the corresponding class feature. Such a group feature comparison can be undertaken in addition to an individual feature comparison.

Expediently a variance, which is taken into account in the feature comparison, is associated in each case with the class feature. The variance can include a fluctuation that the feature usually exhibits for various identical products of this class. Possible examples are form variance, in order not to take account of cardboard box dents and film changes incorrectly as class-separating features. Also color variances, in order to exclude fading as a source or errors for example, are advantageous, as well as image structure variances, to enable soiling to be tolerated. Especially advantageous are alignment variances to enable objects aligned differently to a camera capturing the image to be classified correctly.

A further advantageous embodiment of the invention makes provision for the object characteristic to contain object features and for these to be divided up into different levels. Expediently the first level on the object contains one or more visible figures, such as characters, i.e. letters and/or digits, character strings, symbols, pictograms, images, ID codes such as barcodes and/or the like. Object dimensions can also be assigned to the first level. A second level can contain geometrical relationships of the figures, such as the location of a figure in an image of the object, the distance of two figures from one another, the angle of a line between two figures with a reference line, e.g. the horizontals, and/or the angle of two or three lines between three figures of the object. Color gradients can also be assigned to the second level.

The features of the two levels can be used in different ways for the comparison. One option consists of the comparison taking place in at least two consecutive steps building on each other, which are expediently executed after one another. In the first step one part of the object features is used exclusively, e.g. the features of the first level, and in the second step other object features are used, e.g. the features of the second level, especially exclusively these features.

It is further advantageous, in a first step, to reduce the set of the class characteristics to a subset in a pre-selection. This subset can be used in the second step as a search space, so that there is a reduction in the search space from the first step to the second step. In the second step an object candidate list can be created from the subset. Advantageously this comprises those class characteristics, which have achieved a comparison value above a threshold value in the comparison and/or an especially predetermined number of class characteristics with the best comparison values. Subsequently the object characteristic is associated with a class characteristic from the candidate list and through this is arranged or classified into the corresponding class.

Advantageously the object is captured optically from a number of sides and an alignment variance of the object is taken into account during the comparison of the object characteristic with the class characteristics. In this way it can be avoided that the alignment of the object, on a transport means for example, makes a classification impossible or leads to an incorrect classification result. An alignment variance can be understood as the classification result remaining essentially the same regardless of the alignment of the object, i.e. being at least essentially independent of the alignment of the object.

The dimensionality of the alignment variance is expediently predetermined here, wherein a one- or two-dimensional variance is also possible. Thus a cardboard box with bottles is usually moved past cameras on the transport belt in an upright position. It is therefore sufficient for the alignment variance to take account of a rotation of the cardboard box on the transport means around a vertical axis. A rotation around the horizontal axis can be ignored. The alignment variance expediently detects a variance in form and especially also brightness, since changes in alignment of the object usually lead to changes in the form of the object in the recorded images. Changes in the way that shadows are thrown can lead to changes in brightness of the object in the captured images.

A further advantageous embodiment of the invention makes provision for information other than optical information to be used as additional information in the comparison of the object characteristic with the class characteristics. Such information can be employed, in addition to the optical information, for establishing the comparison result and/or for checking the comparison result, i.e. as plausibility information for checking the comparison result.

Such additional information can be location information of the object for example. Thus for example the information about which objects should be on a transport means can be used as additional information. If there is a list available of objects that are put onto or should be put onto a transport means within a predetermined time window, the list can be used to restrict the classes to be searched through or to be compared. It is also possible to use this list to check the comparison results already obtained.

A further option consists of using the weight of the object as additional information. Thus the object can be weighed on a transport means for example and the weight can be used as additional information for processing the comparison or for checking the comparison result.

It can occur that a product is subject to a re-design by a manufacturer, so that the external appearance of inherently the same product is changed. This can lead to no class characteristic being available for the newly-designed product and to the comparison failing. In general a comparison can fail if the comparison result does not exceed a threshold value. It is also possible that a new product is delivered that is not yet entered into the database however. The comparison also fails here. No class characteristic or class is thus possible for such products. In this case it is advantageous for the non-classified product to be recognized as such a product for which no class is available. Expediently at least one object image of the product is then supplied for video coding. The image can be associated by a user with a—possibly new, i.e. not yet available—class. The object characteristic of the object is now—possibly without any content change—converted to a class characteristic and inserted into the set of existing class characteristics.

The invention is also directed to a method for sorting objects, especially goods. The sorting can include distribution onto a number of transport elements of a transport means. Advantageously the objects are classified by the inventive method. The objects can subsequently be sorted using the classification, i.e. as a function of the sorting, expediently sorted according to the classification.

Furthermore the invention is directed to a device for sorting objects according to object classes, especially containers of goods that expediently consist of a number of contiguous elements, for example in the form of identical individual goods items. The device contains at least one camera to capture the object and expediently a transport means to transport the object, especially to a capture area of the camera. The device further contains a comparison means which is prepared for creating an object characteristic describing the object from the optical data obtained from the captured image, for comparing the object characteristic with a number of class characteristics that are each characteristic for one or more object classes, and to associate the object with at least one class on the basis of the comparison result. Advantageously the device also comprises a sorting device for sorting the objects in accordance with the class association onto various transport elements or transport units.

The description of advantageous embodiments of the invention given above contains numerous features, which in some cases are reproduced in the individual dependent claims as a combination of a number of features. These features can however expediently also be considered individually and combined into meaningful further combinations. In particular these features are able to be combined in each case individually and in any given suitable combination with the inventive method and the inventive device in accordance with the independent claims.

The characteristics, features and advantages of this invention described above, as well as the manner in which they are achieved, will be illustrated in a clearer and easier to understand manner in conjunction with the following description of the exemplary embodiments, which are explained in greater detail in conjunction with the drawings. The exemplary embodiments serve to explain the invention and do not restrict the invention to the combination of features specified therein, not even in relation to functional features. In addition features of any given exemplary embodiment that are suited thereto can also be explicitly considered in isolation, removed from the exemplary embodiment, introduced into another exemplary embodiment to supplement it and/or combined with any given one of the claims.

In the figures:

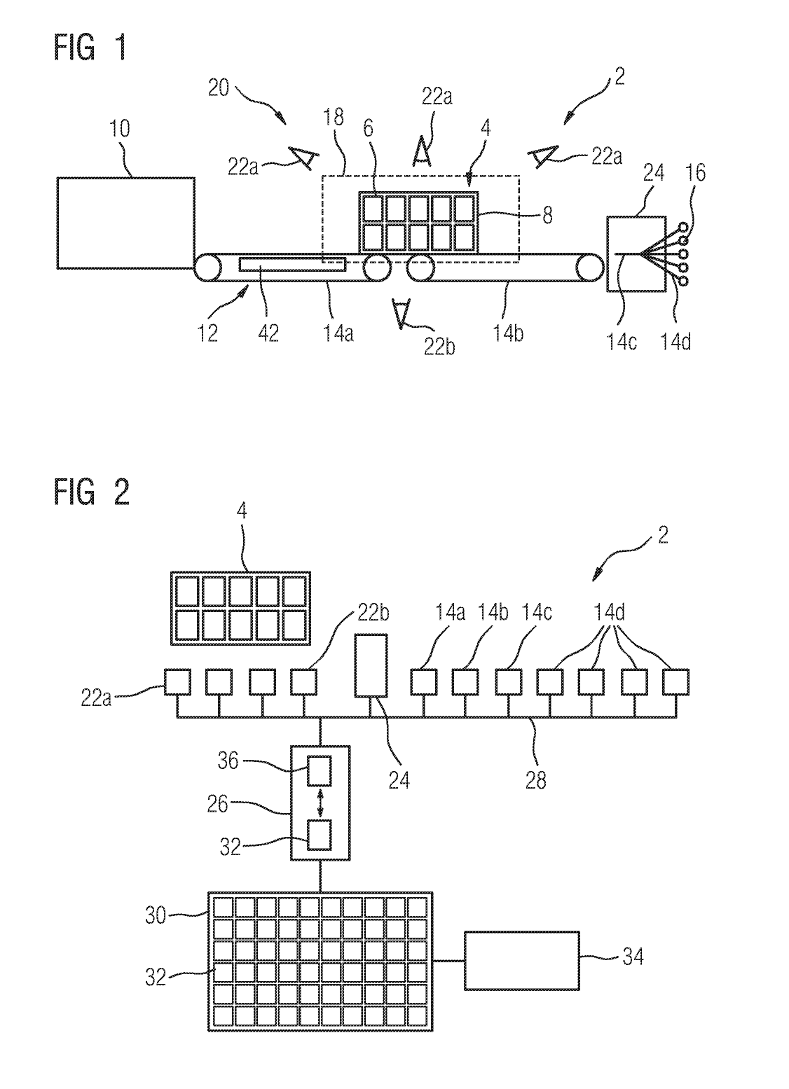

FIG. 1 shows a device for sorting objects,

FIG. 2 shows the device from FIG. 1 in a block diagram,

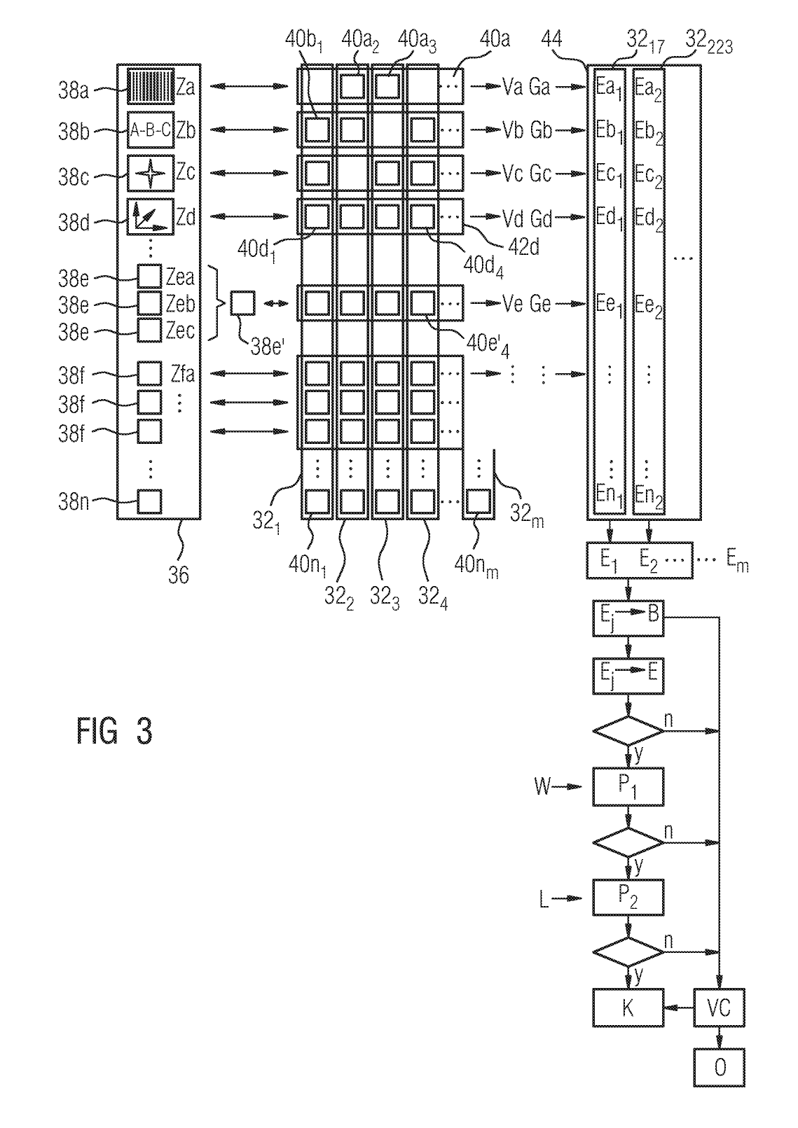

FIG. 3 shows a flow diagram of a classification process with subsequent sorting after the classification,

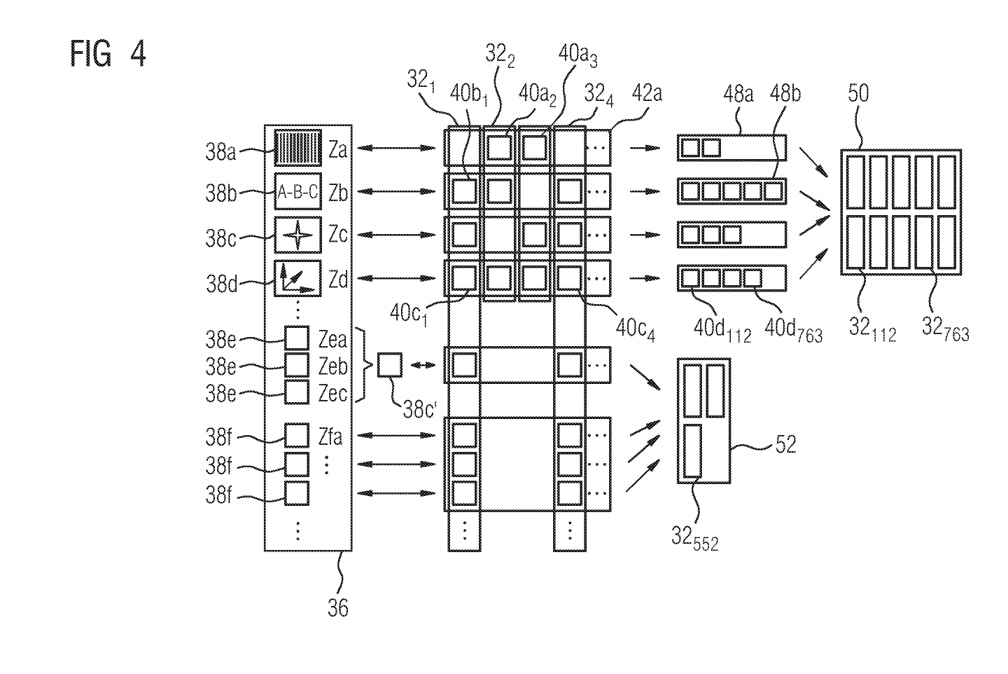

FIG. 4 shows a flow diagram of a further classification process in two consecutive steps,

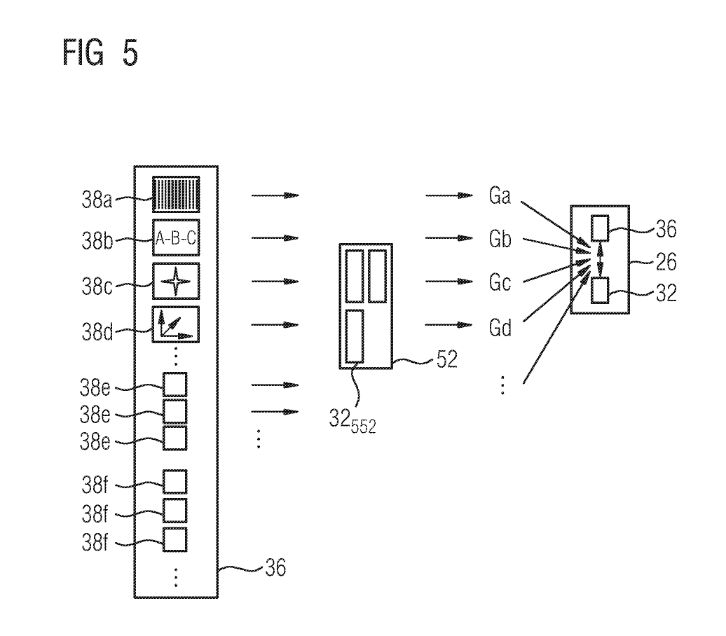

FIG. 5 shows an optional third step with weightings of features,

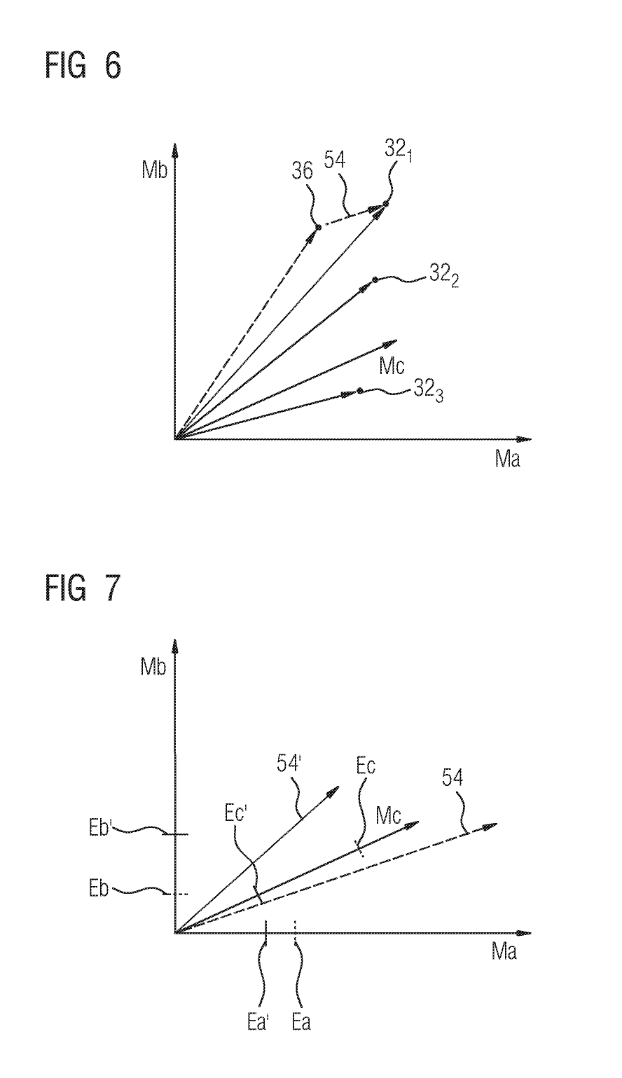

FIG. 6 shows an arrangement of features in a feature space and

FIG. 7 shows a distance between a part of an object characteristic and the corresponding parts of a number of class characteristics and shows how they are changed by weightings.

FIG. 1 shows a device 2 for sorting objects 4, which in this exemplary embodiment are a plurality of goods and of which only one object 4 is shown for the sake of clarity. The object 4 is a container of a number of identical elements, which in this exemplary embodiment are individual goods items 6, for example tins of sweetcorn, which are held together in a container by outer packaging 8. A plurality of such objects 4 are stored in a warehouse 10 and are taken from there and put onto a transport means 12, for example manually or by a feeder. The transport means 12 comprises a number of transport units 14a-14d, which connect the warehouse 10 with a number of unloading stations 16. The transport units 14a-14d can be embodied as transport belts that transport the object 4 from the warehouse 10 to one of the unloading stations 16. Trucks are waiting at the unloading stations 16, to which the objects 4 are taken by the last transport unit 14d.

The warehouse 10 is for example a store of a chain of supermarkets, which are supplied with goods by the individual trucks. The objects 4 are containers or individual goods items, which are sorted according to object types to the unloading stations 16 or trucks, i.e. in accordance with goods or objects 4 with the same contents. With the same contents here means that the objects 4 have a content, such as the individual goods items 6, and an outer packaging 8, wherein the content is the same and the outer packaging 8 can be different. For sorting however the objects 4 are distinguished by object classes or goods classes. An object class contains only optically identical objects 4 with identical content, for which the outer packaging 8 is thus also identical. Objects with usual transport-related or packaging-related optical differences are designated as identical objects and belong to one object class.

In the warehouse 10 a plurality of objects 4 will be placed, e.g. from shelves, on a front part of the transport means 12, which is shown simplified in FIG. 1 by the transport belt 14a, but which can contain a plurality of individual transport elements, such as transport belts. In the transport means 12 there is a point, after which—i.e. in the transport flow below the point—no further object 4 is placed on the transport means 12. The sorting device 2 is disposed in the transport flow beyond this point, by which the objects 4 are classified according to object classes and sorted. To this end the objects 4 are examined optically for sorting.

For this purpose a sorting device 2 with an image capture area 18, a camera system 20 and a comparison means 26 is present. If an object 4 comes into the image capture area 18 on its transport path, it is captured by the camera system 20 from several sides. The camera system 20 contains four cameras 22a-b, of which the three cameras 22a are embodied as two-dimensional cameras and the camera 22b is embodied as a one-dimensional camera, for example as a line-scan camera. The camera 22b is disposed between two transport units 14a, 14b and its field of view is directed between a slot between the transport units 14a, 14b from below onto the object 4. The cameras 22a are directed from above or from a number of sides onto the object 4. The cameras 22a,b each capture one or more images of the object and evaluate said images. The images can be evaluated individually here. However it is also possible to combine image data from a number of images and evaluate it jointly. This can be done by a stitching of images, which are then evaluated as one overall image.

After passing through the image capture area 18 the object 4 is transported to a sorting device 24, which sorts the object 4 onto one of a number of transport units 14d for onwards transport to the corresponding unloading station 16. Each transport unit 14d and/or unloading station 16 is assigned a number of objects 4, which are to be sorted onto the transport unit 14d. In addition it is defined which object classes are to be sorted onto which transport unit 14d. If a number of objects 4 of the same class are sorted, other criteria are included as to which transport unit 14d the currently sorted object 4 is to be sorted onto, e.g. the loading state of a truck or a picking criterion. The objects 4 are sorted onto a transport unit 14d until all objects 4 assigned to the transport unit 14d are sorted.

The device 2 is shown in a schematic block diagram in FIG. 2. The cameras 22 are connected to a comparison means 26, which evaluates the images of the cameras 22. In reference characters with letters, such as cameras 22a, 22b for example, the digits indicate the type and the letters indicate the location of the item. For items with the same label, the same items or similar with essentially the same function are involved, such as the transport belts 14 or the cameras 22. If the label is mentioned alone without a reference letter then all corresponding items are referred to in general.

The cameras 22 are connected to a data bus 28, to which the sorting device 24 and the transport units 14 are also connected. As an alternative a point-to-point connection is also possible between cameras 22 and comparison means 26.

Also connected to the comparison means 26 for signaling purposes is a data memory 30, which contains a plurality of class characteristics 32. Via an updating means 34 the database of the data memory 30, i.e. its class characteristics 32, is kept updated, wherein the updating means 34 removes class characteristics 32 from the data memory 30 and inserts others into said memory 30.

To recognize the container on the transport means 12 the images of the cameras 22 are evaluated by the comparison means 26. To do this, the comparison means 26 creates an object characteristic 36 from the image data, which it compares with the individual class characteristics 32 or parts thereof, as is indicted in FIG. 2. That class characteristic 32 that best fulfills a predetermined comparison criterion during this comparison, e.g. achieves a highest comparison value, which for a successful comparison must lie above a threshold value, specifies the class of the object 4. The object 4 is classified into this class, which thereby designates or characterizes the object 4 or goods container that was captured by the cameras 22 on the transport means 12. An assignment of the individual object classes to the unloading stations 16 is stored in the comparison mans 26, so that the object 4 can now be sorted in accordance with the object class by the sorting device 24 onto the corresponding transport unit 14d, so that the object 4 reaches its unloading station 16.

The comparison of the object characteristic 36 with the class characteristics 32 is shown in greater detail in a first exemplary embodiment in the flow diagram from FIG. 3.

From the images captured by the cameras 22 the comparison means 26 creates a number of object features 38, which in total are the object characteristic. Inter alia the following object features 38 are used for the comparison of the object characteristic 36 with the class characteristics 32.

The object features 38a-c are figures that are visible on the outer packaging or on an individual goods item 6. The object feature 38a is an ID code feature, for example a barcode feature. If such an identifying code is found on the outer packaging 8 of the object 4, then this is included in the object feature 38a. In order to find such a code, the images of the cameras 22 are evaluated by means of image-processing methods for such a code or also for script, numbers and other characters.

The object feature 38b specifies characters such as letters and/or digits on the outer packaging 8 of the container or object 4 or an individual goods item 6. Such script can be a primary designation, i.e. a designation that directly specifies the goods of the container. A secondary designation is also possible, for example a weight of the goods item within the individual goods items 6, a weight of the object 4, a size, a manufacturer specification or the like. Packaging specifications, which identify the packaging per se, for example the name of a manufacturer of the packaging, an environmental sign or the like, are counted as secondary script features.

If the object 4 contains symbols, pictograms and/or images, then these are assigned to the group of object features 38c.

Object dimensions are further established from the images of the object 4. For this the sorting device 2 can contain dimension objects, e.g. one or more dimensions, which are mapped in the images and make it possible to measure the object 4. Object dimensions are assigned to the group of object features 38d.

The object features 38e are for example colors or color graduations on the outer packaging 8 and/or on an individual goods item 6. The object feature 38e consists of a number of elements, which each comprise a color channel red, green, blue of a captured image of one of the cameras 22. Such a captured image of the object 4 can thus be divided up into three images that each specify a color channel. Naturally it is also possible to use more than three color channels, e.g. in order reliably to differentiate between or recognize specific colors.

The object feature 38f comprises a number of individual features, which each specify a distance between figures, a rotational position of figures in space, an angle of a line between figures and a reference line and/or an angle between at least three figures. For the sake of clarity only three such object features 38f are shown in FIG. 3, wherein in reality far more can be present.

Form features of the object 4 as seen by one of the cameras 22 can also be a feature 38f. The form of the object 4 as seen by cameras 22 opposite one another, such as for example the camera 22a looking from above onto the object 4 and the camera 22b looking from below onto the object 4 can be the same, if for example only an outline of the object 4 is captured. It is however also possible for the form features to contain other contours, height geometries and the like, if the image processing is capable of detecting these elements.

The sum of the object features 38 can be seen as elements of a vector of the object characteristic 36. The individual object features 38 are the vector elements of the vector. A number of contiguous elements, such as the elements 38e, can be seen as subvectors, which per se again form a vector, which can be seen on its own or as part of the total vector of all object features 38. Such subvectors or groups of features can either be compared individually, like the object features 38f, or compared as a group, like the object features 38f.

The individual elements of the object feature 38e can each be compared per se with corresponding class features 40e. It is however also possible to form a new object feature 38e′ from the individual elements of the object features 38e, which specifies the overall form of the object 4. This overall form feature can now be compared with the class features 40e′ of the feature type of the overall forms.

The individual object features 38 are now compared with the corresponding class features 40 by feature type. Thus the object feature 38 of one type, for example a script feature 38b, is compared with the class features 40b of the same type. Or the barcode feature 38a of the object 4—if present—is compared with the corresponding barcode features 40a of the individual class characteristics 32_{1 . . . m}.

Each class characteristic 32_{1 . . . m} of the available classes j=1 . . . m contains one, no or a number of class features 40 for each feature type i=a . . . n. For example the class characteristic 32₁ has no barcode feature 40a₁ for it but a number of script features 40b₁, for example a number of letters, digits and/or character sequences, such as names or words.

Each object feature 38 of a type i is compared with the class features 40i₁ . . . 40iₘ of the same type i of each class. The class features 40iⱼ thus form a search space 42i of the feature i.

Thus, to carry out the method, first of all the object 4 is captured by one or more of the cameras 22. The object features are extracted from the image or the images i.e. recognized as such and allocated to a feature class or a feature type. Thereafter a comparison of object features 38 with class features 40 is carried out. Thus for example the object feature 38a—if present—is compared with each of the available class features 40a₁ . . . 40aₘ.

In the exemplary embodiment of FIG. 3 all object features 38 present on the object 4 are compared in this way with the available class features 40 of the same type in each case. A comparison value is created for each comparison, which specifies the quality of the comparison. The class features 40a₁, which achieve a comparison value above a threshold value, are assigned to the object feature 38a in result values Ea.

Each class feature 40 is part of a class characteristic 32. To this extent each class feature 40aᵢ that achieves a comparison value above a threshold value, delivers a corresponding class characteristic 32 in a result list 44. The class characteristic 32₁₇ and 32₂₂₃ are shown by way of example in FIG. 3.

The procedure is the same with the other object features 38i, so that the result list 44 comprises a plurality of class characteristics 32. For each of their class features 40 a result value Ea, Eb, . . . is present. Each result value Ea, Eb, . . . is linked in each case according to a predetermined mathematical algorithm to two parameters, namely a variance V and a weighting G. The factor Va specifies the parameter of the variance of the class feature 40a. The greater is the variance, the smaller is the factor Va. The variance V can be the same for all class features of one type in all classes. Mostly however the variance of one feature type will differ from class to class, e.g. because the form of film packaging is more variable than that of a cardboard box.

The factor Ga specifies the parameter of the weighting of the class feature 40a. Thus for example the weighting of the ID code feature 38a is greater than the weighting Gb of the script feature 38b and this in its turn is greater than the weighting Gc of the form feature 38c and that of the individual color features 40d, since for example the color on the outer packaging 8 can change considerably through fading. The weighting factor G can also be the same for all class parameters of one type or can vary from class to class within one type.

In addition each object feature 38 is assigned a reliability parameter Z. This has been established empirically beforehand and allocated to the individual object features 38 in each case. If for example the quality of a captured image is low, because the object 4 is not contained entirely in the image for example, a lens is dirty or the like, this can be taken into account in the reliability parameter Z. This reliability parameter Z can relate to one image overall, i.e. all object features 38, or can be assigned to the individual elements of the object features, so that thus a reliability parameter Za will be assigned to the object feature 38a, the reliability parameter Zb will be assigned to the object feature 38b etc.. The reliability is also calculated into the individual results Ea, Eb . . . , like the weighting G for example.

For each class characteristic 32 of the result list 44 an overall result Eⱼ is calculated from the result values Ea, Eb . . . , for example by summation of the individual results Ea, Eb . . . or by another method stored in the comparison means 26. The overall result Eⱼ is a result value, which shows the quality of the result. If this result value Eⱼ lies below a threshold value, the quality of the result is unacceptable and an error rate during the classification is to be seen as too high. To this extent each of the result values Eⱼ is compared in a test step with the threshold value B and discarded (n) if the threshold value is not reached. The remaining result values Eⱼ form a candidate list, from which one result value E is sought by the comparison means 26 with a predetermined algorithm and is selected as the comparison result.

If none of the result values Eⱼ reaches the threshold value B, then the automatic classification fails (n) in this case. One image or a number of images of the object 4 are fed to video coding VC. In this video coding the images are displayed on a screen and an operator identifies the object 4 and in this way undertakes a classification K, by allocating to the object 4 a goods item or its object class respectively. During this process the object is guided into a transport loop and transported there for e.g. 30 seconds, before it is guided back onto the transport belt 14b for sorting.

The operator also decides whether the classification has failed because of an error, e.g. because the object 4 could not be classified because of soiling or damage, or whether a new object class or object type is involved. In this case the comparison means 26 sorts the object characteristic 36 as a new class characteristic 32 into the set of the class characteristics 32, so that this set has a new class characteristic 32. Further objects 4 of this class are now classified automatically.

Usually the overall result E will exceed (y) the threshold value however. Two plausibility checks P₁ and P₂ are now carried out to check the result E. Further information is used for this, expediently information other than optical information. For example the weight W of the object 4 is measured. This is done by a set of scales 46 (FIG. 1), which is present in the transport unit 14a. The comparison means 26 or the data memory 30 contains a weight for each class. Since the result E associates an object class with the object 4, the weight of the product or of the class is known. This class weight can be compared with the measured weight W of the object 4. If the theoretical weight of the object 4 lies within a tolerance band W±x% around the measured weight W, then the plausibility test P₁ is successful (y). If on the other hand the plausibility test P₁ is not successful (n), then an image of the object 4 or a number of images are submitted for video coding VC.

The second plausibility check P₂ uses an object list L, which contains such objects 4 as have been placed on the transport means 12 or are to be placed on it within a time window before the capturing of the images of the object 4. This object list L contains a product list and therefore a class list, since a product and an associated class can be seen as equal in value. Through the overall result E the object 4 is associated with an individual object class and thereby identified as a specific product. If this object 4 or product is present on the object list (y), then the plausibility check P₂ is successful. If the product does not match the object list L, i.e. is not present on this list, the plausibility check P₂ fails (n). In order to arrive at a classification despite this, video coding VC can be carried out for example.

If both plausibility checks P₁, P₂ are successful, the ultimate classification is carried out and the object 4 is thus finally associated with an object class. The class is now used for the subsequent sorting S in the sorting device 24, which conveys the object 4 in accordance with the classification onto one of the transport units 14d and thus for transport to a unloading station 16.

It can occur that even the video coding does not lead to a satisfactory result. The reason for this can be that a product or object 4 is so heavily damaged that it cannot be recognized in an automated manner and the operator of the video coding comes to the conclusion that this object 4 is not to be transported any further. Through a corresponding command entered by the operator this object 4 is sorted out in method step O. The possibility also exists that the object 4 is incorrect to the extent that is not to be transported to any unloading station 16. If for example the object 4 has been mistaken and an incorrect product placed on the transport means 12, then this is recognized in the second plausibility check P2 and confirmed by the video coding VC. The object 4 is sorted out in method step O.

FIG. 4 shows a further classification method with a few modifications compared to the method from FIG. 3. The description given below is essentially restricted to the differences from the exemplary embodiment from FIG. 3, to which the reader is referred in relation to components and functions that remain the same. Components that essentially remain the same are basically labeled with the same reference characters and features not mentioned are transferred into the exemplary embodiments below without being described once again.

The comparison is made in two stages. For this the object features 38 are divided into two levels: The figures visible on the object 4, i.e. the object features 38a-c, and the object dimensions form features of the first level. The color features 38e and the geometrical relationships 38f of the figures form features of the second level.

In the first stage the object features 38a-d of the first level are used in a pre-selection to reduce the set of the class characteristics 32 to a subset. To this end the object features 38a-d are compared with the corresponding class features 40a-d, as described in FIG. 3. Each comparison leads to a number of suitable class features 40, which are combined into corresponding candidate lists 48. For example the class features 40d₁₁₂ and 40d₇₆₃ are shown. Since it is possible that some object features 38a-d only occur rarely, such as e.g. the barcode feature 38a, the candidate lists 48 comprise different numbers of class features 40. Since each class feature 40 belongs to a class characteristic 32, an—as a rule smaller—sum of class characteristics 32 is connected with the sum of the class feature 40. All class characteristics 32 derived in this way from the candidate lists 48 form the subset 50 of the class characteristics 32. In FIG. 4 the class characteristics 32₁₁₂ and 32₇₆₃ are shown by way of example, which have been derived from the comparison of the feature 38d. This subset 50 forms the search space for the second step of the comparison.

In the second step the features 38e-f are used to restrict the number of class characteristics 32 of the subset 50 to a maximum number of ten for example, which form an object candidate list 52. In FIG. 4 the object candidate list 52 forms three class characteristics 32. For this the arrangements of the figures of the object 4 or of its object characteristic 36, which were found in the class characteristics 32 of the subset 50, are compared with the corresponding class features 40f. Since the class characteristics 32₂ and 32₃ do not belong to the subset 50, they are not taken into consideration in the second step, as is indicated in FIG. 4.

As FIG. 4 shows, the object candidate list 52 comprises three class characteristics 32, which could suit the object 4. The comparison therefore does not lead in the two steps to a unique result. This can be attributable to a manufacturer having delivered a plurality of very similar goods or containers that are difficult to distinguish.

In order still to arrive at a unique result despite this, the object features 38, in a third step of the comparison, are weighted with a weighting factor Gi. This is shown in FIG. 5. For this it is established how often the individual object features 38 are found in the candidate list 52. The more often they are found, the lower they are weighted, so that they are weighted reciprocally to the frequency of their occurrence in the class characteristics 32. The reciprocity does not have to be linear here.

In the third step the object characteristic 36 is thus compared with the class characteristics 32 of the object candidate list 52, as is shown in FIG. 5, wherein the weighting factors Gi are included in the comparison, in that they are multiplied by the respective result of the individual feature comparisons for example. Subsequently the best result is established as comparison result. This can be subjected to the plausibility checks P, as is described for FIG. 3. It is also possible that the comparison fails and video coding is carried out, as is described for FIG. 3.

After the successful classification the object 4 will be fed to the sorting device 24 and sorted to the correct unloading station 16 in accordance with the classification.

FIG. 6 shows three class characteristics 32₁₋₃ by way of example, which form points in a feature space, which is spanned in the example shown by the features Ma, Mb and Mc. Usually the feature space will involve a multidimensional space, of which the number of dimensions is equal to the number of features M used, which are present in the set of all class characteristics 32.

The object characteristic 36 also forms a point in the feature space, which in each case has a distance to the class characteristics 32₁₋₃. In a first approximation, although the distance forms a criterion for the similarity of the object characteristic 36 with the class characteristics 32₁₋₃, as is described for FIG. 3 and FIG. 4, weightings play a large role in the comparison of the object characteristic 36 with the class characteristics 32₁₋₃.

FIG. 7 shows the influence of the weightings Gi on the distance 54. The distance 54 from FIG. 6 is shown enlarged in FIG. 7. The weightings Gi lead to the results Ei forming the distance for example being modified to the weighted results Ei′. These lead to a modified “distance” 54′, which can be used as the measure for a comparison result. This modification by weighting can be carried out in each of the three steps of the comparison.

1-15. (canceled)

16. A method for associating objects with object classes, which comprises the steps of:
capturing an optical image of an object;
creating an object characteristic describing the object from optical data obtained from the optical image;
comparing the object characteristic with a number of class characteristics being characteristic in each case for one of a number of object classes; and
associating the object with an object class in dependence on a comparison result.

17. The method according to claim 16, wherein the objects are containers storing a number of identical individual goods items packed contiguously in each of the containers and the object classes are container types.

18. The method according to claim 16, wherein the object classes describe a specific goods item.

19. The method according to claim 16, which further comprises forming a new class characteristic from a single new object and inserting the new class characteristic into an existing set of class characteristics, and existing class characteristics remain unchanged and, with the new class characteristic, form a new set, and a comparison is made with the new set.

20. The method according to claim 16, wherein the object characteristic and the class characteristics each form a point in a multidimensional feature space and a comparison takes into account a distance between the point of the object characteristic and points of the class characteristics.

21. The method according to claim 16, wherein the object characteristic contains a number of object features and the class characteristics each contain a number of class features and the object features are compared with the class features.

22. The method according to claim 21, which further comprises allocating each of the object features a feature type that contains a number of elements in each case for a comparison, which in their entirety form a feature search space, and each of the object features is looked for in the feature search space of its feature type.

23. The method according to claim 21, which further comprises weighting the object features reciprocally to a frequency of their occurrence in the class characteristics.

24. The method according to claim 21, which further comprises:
combining at least a few of the object features into groups;
comparing the groups of the object features with corresponding class features in each case and a number of group comparison results are obtained; and
combining the group comparison results into an overall result.

25. The method according to claim 16, wherein the object characteristic contains object features and for a comparison a part of the object features is used to reduce a set of the class characteristics to a subset in a pre-selection and another part of the object features is used to create an object candidate class from the subset.

26. The method according to claim 16, which further comprises capturing the object optically from a number of sides and during a comparison of the object characteristic with the class characteristics an alignment variance of the object is taken into consideration.

27. The method according to claim 16, wherein during a comparison of the object characteristic with the class characteristics information other than optical information is used as plausibility information for checking the comparison result.

28. The method according to claim 16, which further comprises taking into account a weight of the object as the object feature during the comparing step.

29. A method for sorting objects, which comprises the steps of:
associating the objects with object classes, by performing the substeps of:
capturing an optical image of an object;
creating an object characteristic describing the object from optical data obtained from the optical image;
comparing the object characteristic with a number of class characteristics being characteristic in each case for one of a number of object classes; and
classifying the object with an object class in dependence on a comparison result; and
sorting the objects using a classification.

30. A device for sorting objects into object classes, the device comprising:
at least one camera for capturing an image of an object;
a comparator which is configured for creating an object characteristic describing the object from optical data obtained from a captured image, for comparing the object characteristic with a number of class characteristics that are each characteristic for at least one object class, and to associate the object with at least one class on a basis of a comparison result; and
a sorting device for sorting the objects in accordance with a class assignment to various transport units.
